(19) United States
(12) Patent Application Publication
(10) Pub. No.: US 2014/0095183 A1
(43) Pub. Date: Apr. 3, 2014

(54) SYSTEM AND METHOD FOR CONDITIONAL PAYMENT PROCESSING

(71) Applicant: HARTFORD FIRE INSURANCE COMPANY, Hartford, CT (US)

(72) Inventors: Roberto A. Sirica, Farmington, CT (US); Susan V. Rylander, Bristol, CT (US); Glen-Roberts Pitruzzello, Middlefield, CT (US)

(73) Assignee: HARTFORD FIRE INSURANCE COMPANY, Hartford Plaza, CT (US)

(21) Appl. No.: 13/632,629

(22) Filed: Oct. 1, 2012

(51) Int. Cl. G06Q 40/08; G06Q 50/22

(52) U.S. Cl. 705/2

(57) ABSTRACT

According to some embodiments, governmental information associated with an insurance claim may be received. Moreover, a computer processor may automatically populate a lien tracking tool with information based on the received governmental information and the associated insurance claim. Similarly, a conditional payment tool may also be populated with information based on the received governmental information and the associated insurance claim. It may then be automatically arranged for a clinical assessment to be performed in connection with the insurance claim. In accordance with a result of the clinical assessment received by the payment processing system, it may be automatically determined whether an official response letter will be generated or a governmental payment will be issued in connection with the insurance claim.

### BACKGROUND

In some cases, multiple parties may provide payments, or be obligated to provide payments, in connection with an injury. For example, such payments might be associated with both a workers' compensation insurance claim and a governmental program such as Medicare. To qualify as a Medicare beneficiary an injured party might be, for example, at least 65 years old or have been on Social Security disability insurance for at least 24 months. To help reduce the costs associated with Medicare, Federal laws and regulations require insurance companies to report claims at the time of payment if the claimant is eligible for Medicare. Medicare is established as a secondary payer and Medicare is entitled to recover any “conditional payments” that were previously made. For example, if a worker is injured and receives treatment that is paid for by Medicare, the Medicare program may later recover payments from any workers' compensation plan that was obligated to cover that treatment.

To facilitate such recovery, an insurance company may identify and report all Medicare beneficiaries in a claim population. This may be associated with, for example, a quarterly report including specified data elements (e.g., a claimant's name, date of birth, date of injury, etc). When Medicare identifies a claim with potential conditional payments, a lien notice may be issued to the insurance company which must then respond to the lien within specified time frames (e.g., by issuing payment or disputing the lien). Failing to conform to these requirements can result in penalties and/or a loss of rights for an insurance company (e.g., the insurance company may be precluded from disputing a lien). It can be difficult, however, to perform such tasks in an efficient, timely, and accurate manner, especially when a substantial number of insurance claims are involved (e.g., hundreds of thousands of potential insurance claims each quarter). Thus, improvements in Medicare payment processing may be desired.

### BRIEF DESCRIPTION OF THE DRAWINGS

FIG. 1 is block diagram of a system to facilitate Medicare payment processing in accordance with some embodiments.

FIG. 2 illustrates a method according to some embodiments of the present invention.

FIG. 3 is a workflow diagram that might be associated with workers' compensation insurance claims in accordance with some embodiments.

FIG. 4 is a block diagram of a Medicare payment processing platform in accordance with some embodiments of the present invention.

FIG. 5 is a tabular view of a portion of a payment tracking database in accordance with some embodiments of the present invention.

FIG. 6 is a workflow diagram that might be associated with automobile liability insurance claims in accordance with some embodiments.

FIG. 7 is an example of a Medicare conditional payment analysis display in accordance with some embodiments.

FIG. 8 is an example of a workers' compensation electronic document management viewer display in accordance with some embodiments.

### SUMMARY OF THE INVENTION

According to some embodiments, governmental information associated with an insurance claim may be received. Moreover, a computer processor may automatically populate a lien tracking tool with information based on the received governmental information and the associated insurance claim. Similarly, a conditional payment tool may also be populated with information based on the received governmental information and the associated insurance claim. It may then be automatically arranged for a clinical assessment to be performed in connection with the insurance claim. In accordance with a result of the clinical assessment received by the payment processing system, it may be automatically determined whether an official response letter will be generated or a governmental payment will be issued in connection with the insurance claim.

Other embodiments include: means for receiving governmental information associated with an insurance claim; means for automatically populating, by a computer processor, a lien tracking tool with information based on the received governmental information and the associated insurance claim; means for automatically populating, by the computer processor, a conditional payment tool with information based on the received governmental information and the associated insurance claim; means for automatically arranging for a clinical assessment to be performed in connection with the insurance claim; and in accordance with a result of the clinical assessment received by the payment processing system, means for automatically determining by the computer processor whether an official response letter will be generated or a governmental payment will be issued in connection with the insurance claim.

A technical effect of some embodiments of the invention is an improved and automated governmental program processing system for insurance companies, producers, and agencies. With this and other advantages and features that will become hereinafter apparent, a more complete understanding of the nature of the invention can be obtained by referring to the following detailed description and to the drawings appended hereto.

### DETAILED DESCRIPTION

In some cases, multiple parties may provide payments, or be obligated to provide payments, in connection with an injury. For example, such payments might be associated with both a workers' compensation insurance claim and a governmental program such as Medicare or a similar state or federal governmental program. To qualify as a Medicare beneficiary, an injured party might be, for example, at least 65 years old or have been on Social Security disability insurance for at least 24 months. Although the Federal Medicare program is described herein as an example, note that embodiments might be associated with similar programs, including programs adjusted or enacted in the future.

To help reduce the costs associated with Medicare, Federal laws and regulations require insurance companies to report claims at the time of payment if the claimant is eligible for Medicare. Moreover, Medicare is precluded from paying for the claimant's medical expenses when payment has been made or can reasonably be expected to be made under a workers' compensation plan, an automobile or liability insurance policy, or under a no-fault insurance program. Medicare is established as a secondary payer and has a priority right of recovery over any other entity to the proceeds of any settlement. To the extent that Medicare has made any “conditional payments,” Medicare is entitled to recover those payments. For example, if a worker is injured and receives treatment that is paid for by Medicare, the Medicare program can later recover payment from any workers' compensation plan that was obligated to cover that treatment.

To facilitate such recovery, an insurance company identifies all Medicare beneficiaries in a claim population. This may be associated with, for example, a quarterly report including specified data elements (e.g., a claimant's name, date of birth, date of injury, etc). When Medicare identifies a claim with potential conditional payments, a lien notice may be issued to the insurance company which must then respond to the lien within specified time frames (e.g., by issuing payment or disputing the lien). Failing to conform to these requirements can result in penalties and/or a loss of rights for an insurance company (e.g., the insurance company may be precluded from disputing a lien). It can be difficult, however, to perform such tasks in an efficient, timely, and accurate manner, especially when a substantial number of insurance claims are involved (e.g., hundreds of thousands of potential insurance claims each quarter).

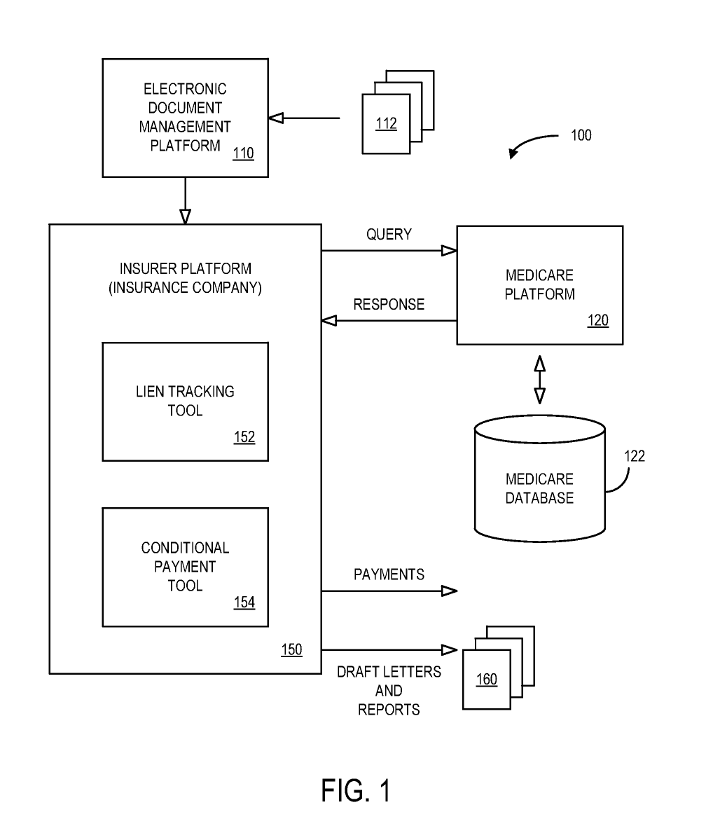

To help reduce such problems, FIG. 1 is block diagram of a system 100 to facilitate Medicare payment processing in accordance with some embodiments of the present invention. In particular, the system includes an electronic document management platform 110 that may receive, for example, conditional payment letters through the mail. The conditional payment letters might be received, for example, from a Medicare secondary payer recover contractor.

The electronic document management platform 110 may process the conditional payment letters (e.g., by scanning them, looking for keywords, and/or matching each letter to an insurance claim file) and transmit Medicare information to an insurer platform 150 associated with an insurance company. According to some embodiments, the insurer platform 150 may periodically transmit queries to a Medicare platform 120 (e.g., transmitting information about insurance claimants on an ongoing or quarterly basis). The Medicare platform 120 may access information in a Medicare database 122 and transmit a response back to the insurer platform 150 to help the insurance company identify potential Medicare beneficiaries.

The insurer platform 150 may receive the Medicare information from the electronic document management platform 110 and process the information via a “lien” tracking tool 152 and/or a conditional payment tool 154. As used herein, the term “lien” might refer to a right of recovery a governmental program has with respect to another party, such as an insurance provider. Moreover, the insurer platform 150 may arrange for payments to be provided in connection with conditional payment letters and/or output reports and/or “automatically” generated draft letters to dispute a potential lien associated with an insurance claim. As used herein, the term “automatically” indicates that at least some part of a step associated with a process or service is performed with little or no human intervention. By way of examples only, the insurance platform 150 might be associated and/or communicate with a Personal Computer (PC), an enterprise server, and/or a database farm.

Any of the devices described in connection with the system 100 may access information in one or more databases. The databases may include, for example, information about insurance claims and/or insurance rules associated with various jurisdictions. Moreover, any of the devices may exchange information via a communication network. These devices (and any of the other devices described herein) could be associated with, for example, a server, a PC, a mobile or laptop computer, or any other appropriate storage and/or communication device to exchange information via a web site and/or a communication network. As used herein, devices (including those associated with the insurance platform 150 and any other device described herein) may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

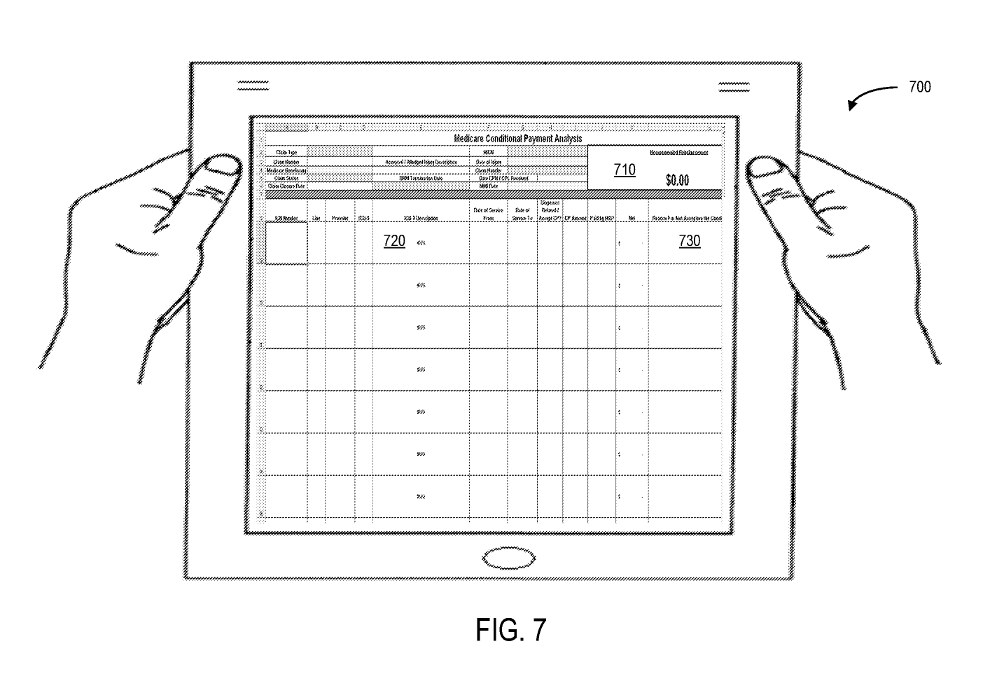

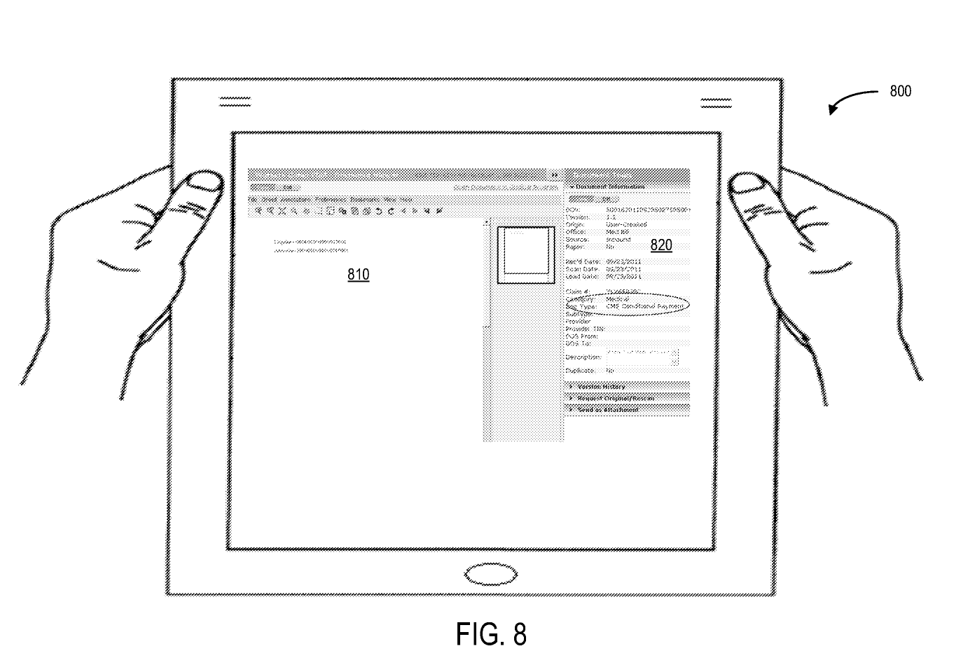

The devices of FIG. 1 might, according to some embodiments, be accessible via a Graphical User Interface (GUI). The GUI might be used, for example, to dynamically display existing lien and payment information, to clinically assess an injury, and to input or output information about liens and/or payments. Some examples of GUI displays are described herein with respect to FIGS. 7 and 8.

Although a single insurance platform 150 is shown in FIG. 1, any number of such devices may be included. Moreover, various devices described herein might be combined or co-located according to embodiments of the present invention.

The insurance platform 150 might include, for example, a communication device to receive information from one or more electronic document management platforms 110. The electronic document management platforms 110 might be associated with, for example, a scanning service, optical character recognition applications, etc.

The insurance platform 150 might further include a processor coupled to the communication device and a storage device in communication with the processor and storing instructions adapted to be executed by said processor to facilitate the Medicare payment processing in accordance with any of the embodiments described herein.

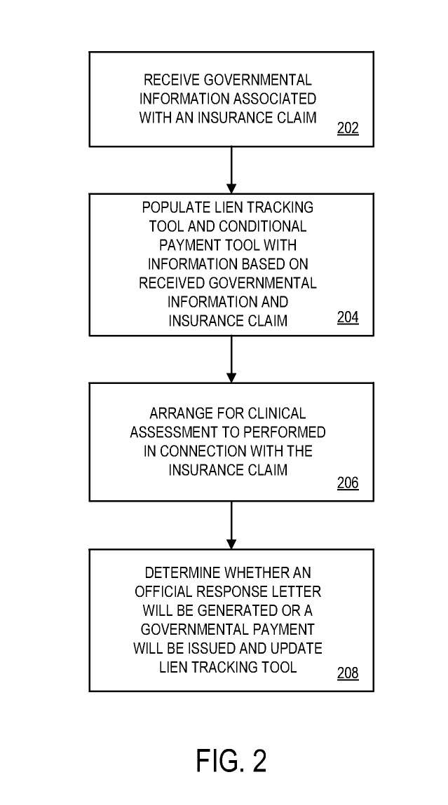

FIG. 2 illustrates a method that might be performed, for example, by some or all of the elements of the system 100 described with respect to FIG. 1 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At Step 202, governmental information associated with an insurance claim may be received. The insurance claim might be associated with a Medicare program, a workers' compensation insurance claim, and/or an automobile managed care insurance claim. As other examples, the insurance claim might be associated with an automobile liability insurance claim or a general liability insurance claim. The received governmental information might be associated with, for example, a conditional payment letter received from a Medicare secondary payer recovery contractor (e.g., after the letter is processed by an electronic document management platform).

At Step 204, a lien tracking tool may be populated with information based on the received governmental information and the associated insurance claim. Similarly, a conditional payment tool may be populated at Step 204 with information based on the received governmental information and the associated insurance claim. Note that the conditional payment tool might be associated with a spreadsheet application. Moreover the population of the conditional payment tool may further include facilitation of entry of International Classification of Diseases (“ICD”) information for the insurance claim. For example, an ICD code and/or description might be automatically suggested by the conditional payment tool. In addition to ICD information, the lien and/or payment processing tools might store, for example, a claim type, a claim number, a date of injury, a governmental beneficiary, an injury description, a claim handler, a claim status, a date the conditional payment notice was received, a claim closure date, a termination date, a maximum medical improve date, a provider, a date of service start, a date of service stop, a conditional payment amount, an indication of whether an insurer has previously paid for the claim, and/or a net payment amount.

At Step 206, it may be automatically arranged for a clinical assessment to be performed in connection with the insurance claim in accordance with information in the conditional payment tool. For example, information in the conditional payment tool might be used to create an entry in a clinical assessment queue associated with a workflow.

In accordance with a result of the clinical assessment received by the payment processing system, at may be automatically determined at Step 208 whether an official response letter will be generated or a governmental payment will be issued in connection with the insurance claim. For example, if it is determined that the conditional payment letter was correct, payment to a governmental program may be authorized. If it is determined that the conditional payment letter may have been issued in error, a draft official response letter may be automatically created (e.g., to be reviewed and issued within a specified time period). In either case, the lien tracking tool may be automatically updated based on said determination. According to some embodiments, the system may further be adapted to periodically generate an outstanding lien report. Moreover, according to some embodiments, the automatic determination of whether an official response letter will be generated or a governmental payment will be issued may be based at least in part on a statute of limitations associated with the insurance claim and/or a jurisdiction associated with the insurance claim. Further note that according to some embodiments, it might be automatically determined that a partial governmental payment will be issued along with an official response letter disputing a portion of the insurance claim

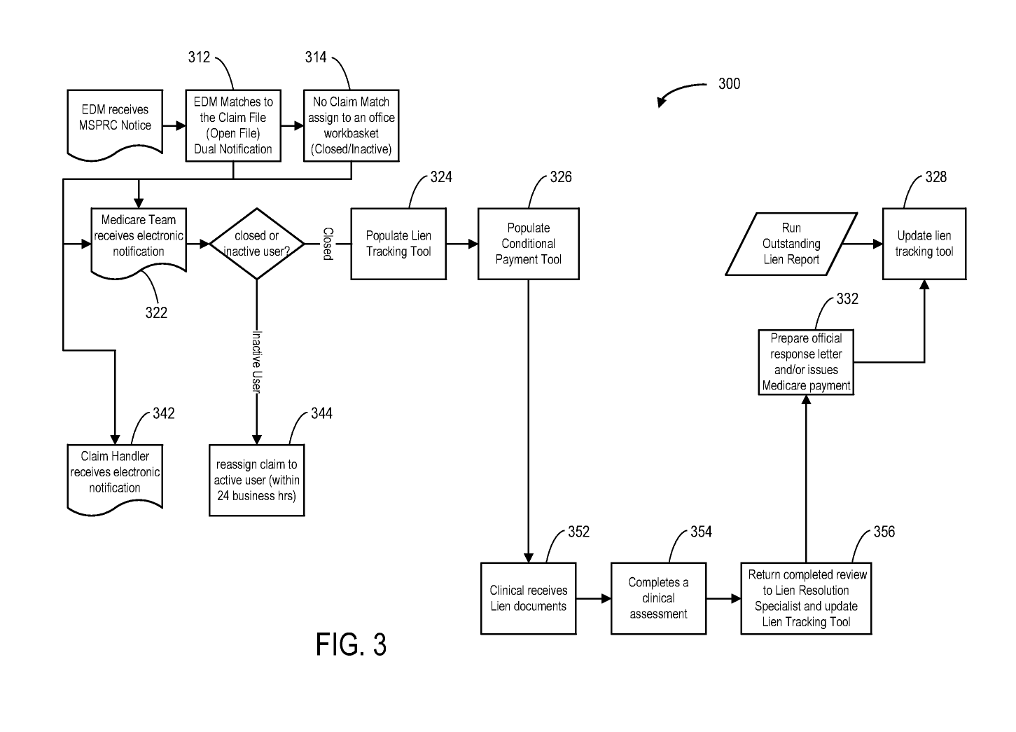

FIG. 3 is a workflow diagram 300 that might be associated with, for example, workers' compensation insurance claims in accordance with some embodiments. After an Electronic Document Management (“EDM”) platform processes a Medicare secondary payer recovery contractor notice (e.g., a conditional payment letter), the EDM platform may match the notice to a workers' compensation insurance claim file at 312 and generate dual notifications. If the claim cannot be matched, it is assigned to an office workbasket 314 for manually processing.

One of the notifications generated at 312 may be provided to a claim handler via an electronic notification at 322. The other notification generated at 312 may be provided to a Medicare operations support team via an electronic notification at 322. The support team may determine if the workers' compensation insurance claim is closed or associated with an inactive user (such as an inactive claim handler). In the event that the workers' compensation insurance claim is associated with an inactive user, it may be reassigned by a claim center to an active user (e.g., within 24 business hours) at 344.

Otherwise, a lien tracking tool may be populated at 324, and a conditional payment tool may be populated at 326. After the conditional payment tool is populated, it may be automatically arranged for a clinical specialist to receive lien documents at 352. The clinical specialist may complete a clinical assessment of the workers' compensation insurance claim at 354 and return a completed review to a lien resolution specialist who may then update the lien tracking tool at 356. The review may include, for example, the clinical specialist's opinion as to whether or not the injury was in fact a valid workers' compensation claim. For example, there might be a difference of opinion as to whether or not an on-the-job back injury that occurred when a worker was 40 years old is the actual cause of a treatment he or she received at the age of 70 years old.

An official response letter may then be prepared or a Medicare payment may be issued, as appropriate, at 332. The lien tracking tool may then be updated at 328 to reflect the status of workers' compensation insurance claim and used to run outstanding lien reports when needed (e.g., on a quarterly basis).

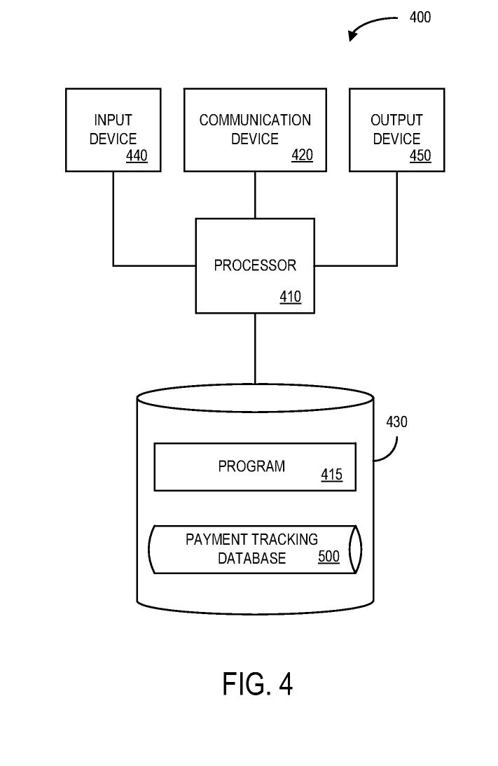

Some of the elements in the workflow 300 of FIG. 3 may be performed or facilitated by a Medicare payment processing platform associated with an insurer. FIG. 4 is a block diagram of a Medicare payment processing platform 400 in accordance with some embodiments of the present invention. The platform 400 might, for example, comprise a platform or engine similar to the insurance platform 150 illustrated in FIG. 1. The platform 400 comprises a processor 410, such as one or more INTEL° Pentium® processors, coupled to a communication device 420 configured to communicate via a communication network (not shown in FIG. 4). The communication device 420 may be used to exchange Medicare and/or insurance claim information, for example, with one or more remote devices, such as a remote electronic document management platform.

The processor 410 is also in communication with an input device 440. The input device 440 may comprise, for example, a keyboard, a mouse, or computer media reader. Such an input device 440 may be used, for example, to enter information about insurance claims, including ICD information, etc. The processor 410 is also in communication with an output device 450. The output device 450 may comprise, for example, a display screen or printer. Such an output device 450 may be used, for example, to provide reports and/or draft letters associated with insurance claims and conditional payment letters.

The processor 410 is also in communication with a storage device 430. The storage device 430 may comprise any appropriate information storage device, including combinations of magnetic storage devices (e.g., hard disk drives), optical storage devices, and/or semiconductor memory devices such as Random Access Memory (RAM) devices and Read Only Memory (ROM) devices. The storage device 430 stores a program 415 for controlling the processor 410. The processor 410 performs instructions of the program 415, and thereby operates in accordance with any embodiments of the present invention described herein. For example, the processor 410 may receive Medicare information associated with an insurance claim. Moreover, the processor 410 may automatically populate a lien tracking tool with information based on the received Medicare information and the associated insurance claim. Similarly, a conditional payment tool may also be populated with information based on the received Medicare information and the associated insurance claim. The processor 410 may then arrange for a clinical assessment to be performed in connection with the insurance claim. In accordance with a result of the clinical assessment received by the payment processing system, the processor 410 may determine whether an official response letter will be generated or a Medicare payment will be issued in connection with the insurance claim.

As used herein, information may be “received” by or “transmitted” to, for example: (i) the insurance platform 400 from other devices; or (ii) a software application or module within the insurance platform 400 from another software application, module, or any other source.

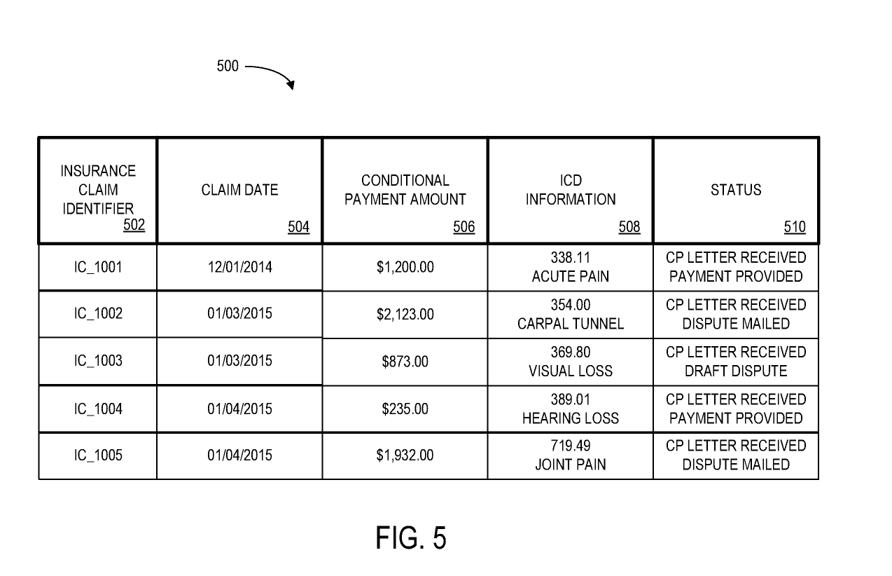

As shown in FIG. 4, the storage device 430 also stores a payment tracking database 500. One example of such a database 500 that may be used in connection with the insurance platform 400 will now be described in detail with respect to FIG. 5. The illustration and accompanying descriptions of the database presented herein is exemplary, and any number of other database arrangements could be employed besides those suggested by the figures. For example, different databases associated with different types of policies or claims might be associated with the insurance platform 400.

FIG. 5 is a tabular view of a portion of the payment tracking database 500 in accordance with some embodiments of the present invention. The table includes entries associated with insurance claims and/or Medicare conditional payment letters. The table also defines fields 502, 504, 506, 508, 510 for each of the entries. The fields specify: an insurance claim identifier 502, a claim date, a conditional payment amount 506, ICD information 508, and a status 510. The information in the database 500 may be periodically created and updated based on information received from Medicare, an electronic document management platform, a clinical specialist, and/or third party service devices.

The insurance claim identifier 502 might be, for example, an alphanumeric code that uniquely identifies an insurance claim, such as a workers' compensation insurance claim or an automobile liability insurance claim, that may be associated with a conditional payment letter received from Medicare. The claim date 504 may represent when a claim was made, when an injury occurred, a date of treatment, a date a conditional letter was received, etc. The conditional payment amount 506 may represent an amount of money that was spent on medical treatment, and amount of money being disputed, etc. The ICD information 508 may represent an ICD code and/or description of an injury associated with the insurance claim. The status 510 might indicate, for example, whether or not a conditional payment letter has been received and/or how the lien was resolved (e.g., by issuing a payment or by mailing a response disputing the classification within a pre-determined time period).

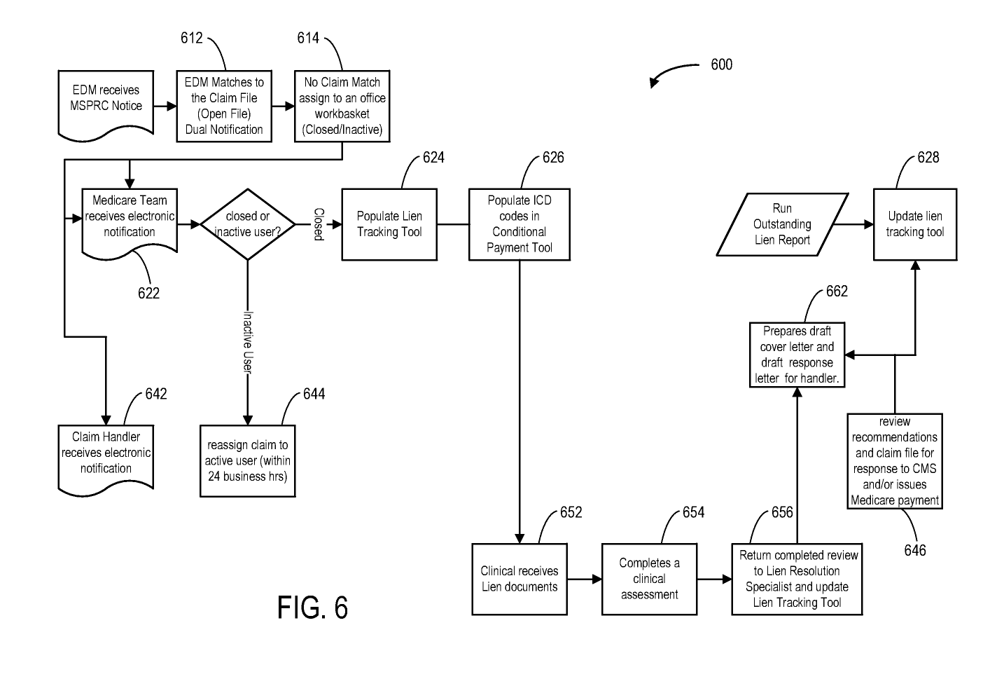

Although workers' compensation insurance claims have been described in some examples herein, note that embodiments might be associated with other types of insurance claims. For example, FIG. 6 is a workflow diagram 600 that might be associated with, for example, automobile liability insurance claims in accordance with some embodiments.

After an EDM platform processes a Medicare secondary payer recovery contractor notice (e.g., a conditional payment letter), the EDM platform may match the notice to an automobile liability insurance claim file at 612 and generate dual notifications. If the claim cannot be matched, it is assigned to an office workbasket 614 for manually processing.

One of the notifications generated at 612 may be provided to a claim handler via an electronic notification at 622. The other notification generated at 612 may be provided to a Medicare operations support team via an electronic notification at 622. The support team may determine if the automobile liability insurance claim is closed or associated with an inactive user (such as an inactive claim handler). In the event that the automobile liability insurance claim is associated with an inactive user, it may be reassigned by a claim center to an active user (e.g., within 24 business hours) at 644.

Otherwise, a lien tracking tool may be populated at 624, and a conditional payment tool may be populated at 626. As part of populating the conditional payment tool at 626, ICD codes and/or descriptions may be suggested and/or entered into the tool (e.g., into a spreadsheet associated with the tool). After the conditional payment tool is populated, it may be automatically arranged for a clinical specialist to receive lien documents at 652. The clinical specialist may complete a clinical assessment of the automobile liability insurance claim at 654 and return a completed review to a lien resolution specialist who may then update the lien tracking tool at 656.

An official response letter may then be recommended or a Medicare payment may be recommended, as appropriate, at 632. A claim handler may then review the recommendation and claim file 646 and approve or adjust the recommendation as appropriate. The lien tracking tool may then be updated at 628 to reflect the status of automobile liability insurance claim and used to run outstanding lien reports when needed (e.g., on a quarterly basis).

Elements of the workflow diagram 600, as well as any of the other embodiments described herein, may be facilitated by the use of one or more GUI displays. For example, FIG. 7 illustrates a Medicare conditional payment analysis display 700 provided on a tablet computer in accordance with some embodiments. Note that the display might instead be associated with a PC, a web page, a smartphone, etc. The Medicare conditional payment analysis display 700 might provide information associated with one or more insurance claims, including a claim type, claim identifier, and a recommended reimbursement amount 710. For each claim, the display 700 might further include an ICD description 720 and an explanation 730 as to why conditional payment for that particular ICD description 720 number is not being recommended. The information on the display 700 might be provided to and/or received from, for example, a nurse or claims handler.

FIG. 8 is an example of a workers' compensation electronic document management viewer display 800 in accordance with some embodiments. The display 800 may list, for example, one or more document names 810 associated with, for example, an insurance claim. The display 800 may further include a document information area 820 displaying, for those documents: a document control number, a version, an origin, one or more dates, a claim number, a category, a document type (e.g., indicating that the document is a CMS conditional payment document), a provider, a description, etc. The information on the display 800 might be provided to and/or received from, for example, a nurse or claims handler.

As a result of the embodiments described herein, the processing of conditional Medicare payments may be provided in an accurate, efficient, and timely fashion.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases and engines described herein may be split, combined, and/or handled by external systems).

Applicants have discovered that embodiments described herein may be particularly useful in connection with Medicare insurance, although embodiments may be used in connection other types of insurance (e.g., similar programs enacted in the future). Moreover, although some embodiments have been described with respect to particular types of insurance, note that embodiments might be useful in other insurance environments (e.g., a no-fault insurance program).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. An automated conditional payment processing system, comprising:
a communication device to receive governmental information associated with an insurance claim;
a processor coupled to the communication device; and
a storage device in communication with said processor and storing instructions adapted to be executed by said processor to:
populate a lien tracking tool with information based on the received governmental information and the associated insurance claim;
populate a conditional payment tool with information based on the received governmental information and the associated insurance claim;
automatically arrange for a clinical assessment to be performed in connection with the insurance claim based on information in the conditional payment tool; and
in accordance with a result of the clinical assessment received by the payment processing system, automatically determining whether an official response letter will be generated or a governmental payment will be issued in connection with the insurance claim, wherein the lien tracking tool is automatically updated based on said determination.

2. The system of claim 1, wherein the insurance claim is associated with at least one of: (i) Medicare, (ii) a workers' compensation insurance claim, and (iii) an automobile managed care insurance claim.

3. The system of claim 1, wherein the insurance claim is associated with at least one of: (i) an automobile liability insurance claim and (ii) a general liability insurance claim.

4. The system of claim 1, wherein the received governmental information is associated with a conditional payment letter received from a Medicare secondary payer recovery contractor.

5. The system of claim 4, wherein the storage device further stores instructions adapted to be executed by said processor to automatically generate an electronic document file associated with a draft official response letter to the conditional payment letter and supporting documentation.

6. The system of claim 5, wherein it is automatically determined that a partial governmental payment will be issued along with an official response letter disputing a portion of the insurance claim.

7. The system of claim 6, wherein said population of the conditional payment tool includes facilitation of entry of an international classification of diseases code for the insurance claim.

8. The system of claim 4, wherein the a storage device further stores instructions adapted to be executed by said processor to automatically track a time period associated with official response letter.

9. The system of claim 1, wherein the a storage device further stores instructions adapted to be executed by said processor to periodically generate an outstanding lien report.

10. The system of claim 1, wherein said automatic determination of whether an official response letter will be generated or a Medicare payment will be issued is based at least in part on at least one of: (i) a statute of limitations associated with the insurance claim and (ii) a jurisdiction associated with the insurance claim.

11. A computer-implemented method to facilitate automated Medicare processing, comprising:
receiving Medicare information associated with an insurance claim;
automatically populating, by a computer processor, a lien tracking tool with information based on the received Medicare information and the associated insurance claim;
automatically populating, by the computer processor, a conditional payment tool with information based on the received Medicare information and the associated insurance claim;
automatically arranging, by the computer processor, for a clinical assessment to be performed in connection with the insurance claim in accordance with information in the conditional payment tool by creating an entry in a clinical assessment queue associated with a workflow; and
in accordance with a result of the clinical assessment received in accordance with the workflow and clinical assessment queue, automatically determining by the computer processor whether an official response letter will be generated or a Medicare payment will be issued in connection with the insurance claim, wherein the lien tracking tool is automatically updated based on said determination.

12. The method of claim 11, wherein the insurance claim is associated with at least one of: (i) a workers' compensation insurance claim and (ii) an automobile managed care insurance claim.

13. The method of claim 11, wherein the insurance claim is associated with at least one of: (i) an automobile liability insurance claim and (ii) a general liability insurance claim.

14. The method of claim 11, wherein the received Medicare information is associated with a conditional payment letter received from a Medicare secondary payer recovery contractor.

15. The method of claim 14, further comprising:
automatically generating a draft official response letter to the conditional payment letter.

16. The method of claim 15, wherein the populating the conditional payment tool includes facilitation of entry of an international classification of diseases code for the insurance claim.

17. The system of claim 14, further comprising:
automatically tracking a time period associated with official response letter.

18. A system, comprising:
a electronic data warehouse device to receive a conditional payment letter from a Medicare secondary payer recovery contractor, to match the conditional payment letter with an insurance claim file, and to transmit information about the conditional payment letter and insurance claim file;
an insurance platform to receive the information about the conditional payment letter and insurance claim file, to populate a lien tracking tool and a conditional payment tool with data based on information about the conditional payment letter and insurance claim file; and
an output port to output a draft official response letter based on an automatically arranged clinical assessment performed in connection with the insurance claim.

19. The system of claim 18, wherein the insurance claim is associated with at least one of: (i) a workers' compensation insurance claim, (ii) an automobile managed care insurance claim, (iii) an automobile liability insurance claim, and (iv) a general liability insurance claim.

20. The system of claim 18, wherein the conditional payment tool is further associated with a storage unit storing at least one of: (i) a claim type, (ii) a claim number, (iii) a date of injury, (iv) a Medicare beneficiary, (v) an injury description, (vi) a claim handler, (vii) a claim status, (viii) a date the conditional payment notice was received, (ix) a claim closure date, (x) a termination date, (xi) a maximum medical improve date, (xii) a provider, (xiii) an international categorization of disease code, (xiv) an international categorization of disease description, (xv) a date of service start, (xvi) a date of service stop, (xvii) a conditional payment amount, (xviii) an indication of whether an insurer has previously paid for the claim, and (xix) a net payment amount.
